(19) United States
(12) Patent Application Publication
(10) Pub. No.: US 2011/0217522 A1
(43) Pub. Date: Sep. 8, 2011

(54) INK-JET PIGMENT INK AND INK-JET RECORDING METHOD USING THE SAME

(75) Inventor: Makoto OHMOTO, Ashigarakami-gun (JP)

(73) Assignee: FUJIFILM CORPORATION, Tokyo (JP)

(21) Appl. No.: 13/042,035

(22) Filed: Mar. 7, 2011

(30) Foreign Application Priority Data
Mar. 8, 2010 (JP) 2010-050976

(51) Int. Cl. B32B 3/10; C09D 11/10; B41J 2/015; B41J 29/38

(52) U.S. Cl. 428/195.1; 523/436; 347/20; 347/17

(57) ABSTRACT

An ink-jet pigment ink containing at least one tri-block copolymer of polyethylene oxide-polypropylene oxide-polyethylene oxide having a number-average molecular weight of 8,000 or more and 30,000 or less and a content of polyethylene oxide of 60% by mass or more and 90% by mass or less with respect to the total mass of the copolymer, wherein a viscosity of the ink-jet pigment ink increases by heating.

### FIELD OF THE INVENTION

The present invention relates to an ink-jet pigment ink, an ink-jet recording method using the same, a printed matter and an ink-jet recording apparatus.

### BACKGROUND OF THE INVENTION

The ink-jet recording has such a lot of advantages that a high-speed recording is possible; a low noise level is achieved; colorization is easy; a high resolution can be made; and a plain paper recording is possible. Because of these advantages, instruments and equipments using such recording method are remarkably in widespread use. As the ink used in this recording method, an aqueous ink is dominant from the viewpoints of safety, odor and the like. In the ink-jet recording method, image formation is performed by ejecting (discharging) the ink in a rate of several thousands or more drops per second.

In the case where a high-speed printing is performed by the ink-jet recording method, aggregation and color bleeding may occur. Specifically, the term “aggregation” signifies a phenomenon in which before absorption of the first ink droplet into a paper has been completed, the second ink droplet reaches to the first ink droplet and they are united or aggregated to form one large liquid droplet. The image resolution is deteriorated by the aggregation. On the other hand, the term “color bleeding” signifies a phenomenon in which image sharpness and color quality are deteriorated on the grounds that two droplets, which are to be united, contain a colorant having a different color from each other.

As a method contemplated to address the problem of color bleeding in a high-speed printing, a method of using an ink that turns into a gel in response to heat, and printing the ink on a recording element (paper) having been heated at a higher temperature than that of the ink is proposed (see JP-A-2003-285532 (“JP-A” means unexamined published Japanese patent application)).

In the mean time, improvement of dot bleeding and suppression of penetration of the ink through the paper (transfer of the ink to the back side of the paper) have been further strongly required for the ink-jet recording pigment ink. The present inventors have confirmed that although the color bleeding is improved by a technique described in JP-A-2003-285532, the effect of improvement is not enough. Especially with respect to the dot bleeding, in the case of printing under high-ejection conditions, the bleeding tends to occur in the second-order color dot. The high-ejection conditions refer to printing under conditions of high dot density and high concentration such that, on top of a certain dot having landed on a recording sheet, a new dot having the same or different color lands. Accordingly, since the dot density is high under the high-ejection conditions, the second-order color dot is formed on top of the first-order color dot. It is presumed that both the first-order color dot and the second-order color dot lose their shapes in this time whereby bleeding occurs in the dot. Further, sometimes, a density on the printing side becomes low due to penetration of the ink through the paper whereby it becomes difficult to obtain a necessary optical density (OD).

### SUMMARY OF THE INVENTION

The present invention resides in an ink-jet pigment ink, comprising: at least one tri-block copolymer of polyethylene oxide-polypropylene oxide-polyethylene oxide having a number-average molecular weight of 8,000 or more and 30,000 or less and a content of polyethylene oxide of 60% by mass or more and 90% by mass or less with respect to the total mass of the copolymer, wherein a viscosity of the ink-jet pigment ink increases by heating.

Further, the present invention resides in an ink-jet recording method, comprising the step of: printing on a recording sheet by ejecting ink droplets from an orifice of a recording head in response to recording signals,

wherein the ink is the ink-jet pigment ink described in the above item, and

wherein the recording sheet is heated to 80° C. or higher before the ink droplets land, or at the time of landing.

Further, the present invention resides in a printed matter comprising a recording sheet having been printed thereon by the ink-jet recording method described in the above item.

Further, the present invention resides in an ink-jet recording apparatus, comprising: a recording unit,

wherein the recording unit is equipped with an ink containing section that contains an ink and a head unit that ejects the ink in the form of liquid droplets,

wherein the ink is the ink-jet pigment ink described in the above item, and

wherein the ink-jet recording apparatus further comprises a heating and retaining means that maintains the temperature of a recording sheet at 80° C. or higher by heating before the ink droplets land, or at the time of landing.

Other and further features and advantages of the invention will appear more fully from the following description.

### DETAILED DESCRIPTION OF THE INVENTION

According to the present invention, there are provided the following means:

(1) An ink-jet pigment ink, comprising: at least one tri-block copolymer of polyethylene oxide-polypropylene oxide-polyethylene oxide having a number-average molecular weight of 8,000 or more and 30,000 or less and a content of polyethylene oxide of 60% by mass or more and 90% by mass or less with respect to the total mass of the copolymer, wherein a viscosity of the ink-jet pigment ink increases by heating.
(2) The ink-jet pigment ink described in the above item (1), wherein the ink contains the tri-block copolymer of polyethylene oxide-polypropylene oxide-polyethylene oxide in an amount of from 2% by mass or more and 15% by mass or less based on the ink.
(3) An ink-jet recording method, comprising the step of: printing on a recording sheet by ejecting ink droplets from an orifice of a recording head in response to recording signals,

wherein the ink is the ink-jet pigment ink described in the above item (1) or (2), and

wherein the recording sheet is heated to 80° C. or higher before the ink droplets land, or at the time of landing.

(4) A printed matter comprising a recording sheet having been printed thereon by the ink-jet recording method described in the above item (3).
(5) An ink-jet recording apparatus, comprising: a recording unit,

wherein the recording unit is equipped with an ink containing section that contains an ink and a head unit that ejects the ink in the form of liquid droplets,

wherein the ink is the ink-jet pigment ink described in the above item (1) or (2), and

wherein the ink-jet recording apparatus further comprises a heating and retaining means that maintains the temperature of a recording sheet at 80° C. or higher by heating before the ink droplets land, or at the time of landing.

Hereinafter, the ink-jet pigment ink (hereinafter referred to simply as “ink”) of the present invention will be described.

The ink of the present invention contains a heat-sensitive material to be hereinafter described and has a property of thickening (increasing of viscosity) in response to heating. The viscosity at 80° C. is preferably 100 mPa·s or more, and more preferably 150 mPa·s or more. The upper limit of the viscosity at 80° C. is not particularly restricted. A relatively higher viscosity is preferred. However, the viscosity is ordinarily 10,000 mPa·s or less. Further, from the viewpoint of controlling ejectability, the viscosity at 30° C. is preferably in the range of from 1 to 20 mPa·s, and more preferably from 3 to 12 mPa·s. In addition, a measuring method of the viscosity in the present invention is as follows.

### (Measuring Method of Viscosity)

Unless otherwise indicated, the viscosity in the present invention refers to an average of the values obtained by measuring a viscosity five times every 100 seconds after the test sample has been adjusted to a predetermined temperature using a temperature-variable type rotational viscometer Physica MCR301 (trade name, manufactured by Anton Paar GmbH). It can be assumed that the viscosity obtained by the above measurement is also achieved on a recording sheet having been heated according to the recording method of the present invention described below. As the measuring conditions, shear rate of 10 (1/s) and rate of temperature rise of 5° C./5 seconds are used.

The thickening behavior of the ink is assumed as follows. The heat-sensitive material in the ink has a polyethylene oxide block structure. When the polymer is dissolved in a medium by hydration, the polymer dehydrates by heating. As a result, polyethylene oxide blocks of the polymer interact with each other whereby the ink turns into a gel, resulting in thickening.

According to the ink of the present invention, it is possible to suppress both aggregation and color bleeding of the ink droplets in a high-speed printing because the ink of the present invention has the above properties. Further, the ink of the present invention makes it possible to suppress both dot bleeding and penetration of the ink through the paper under a high ejection condition while holding the above-described suppression effects of aggregation and color bleeding.

Further, in the case of forming dots with such high-temperature-induced gelation ink according to the ink-jet recording method, a solvent evaporates after increase of viscosity due to gel transition. As a result, the cross-sectional shape of the dot forms a trapezoid or concave. From the viewpoint of density uniformity, a trapezoid is preferred. In the ink of the present invention, the shape of the dots to be formed is excellent whereby print qualities are also improved.

The composition of the ink according to the present invention will be described below.

### [Heat-Sensitive Material]

In the present invention, the ink contains at least one tri-block copolymer of polyethylene oxide-polypropylene oxide-polyethylene oxide (PEO-PPO-PEO) having a number-average molecular weight of 8,000 or more and 30,000 or less and the content of polyethylene oxide of from 60% by mass to 90% by mass with respect to the total mass of the copolymer, as a heat-sensitive material.

The number-average molecular weight of the PEO-PPO-PEO tri-block copolymer, which is an essential component in the present invention, is 8,000 or more and 30,000 or less, and the range of 8,000 to 20,000 is more preferable. If the number-average molecular weight is too small, the dot that has landed on a recording sheet by ejection from a head becomes to have fluidity so that the dot becomes to be mixed with the second-order color dot. As a result, bleeding tends to occur in the dot. On the other hand, if the number-average molecular weight is too large, such large polymer sometimes makes it difficult to obtain a thickening effect (increase in viscosity), or sometimes reduces ejectability of the ink at ordinary temperature. As a result, the ink sometimes becomes difficult to be ejected from a head of the recording apparatus. Thus, the number-average molecular weight affects ink properties.

When described simply as a molecular weight in the present invention, the molecular weight means a number average molecular weight unless otherwise specified, and the molecular weight is a value measured by the following measuring method.

### (Measuring Method of Molecular Weight)

The molecular weight is measured using GPC (gel permeation chromatography) method, unless otherwise specified. The gel packed in the column used for GPC method is preferably a gel having an aromatic compound in the repeating unit, and examples thereof include a gel comprising a styrene-divinylbenzene copolymer. Two to six columns are preferably connected and used. The solvent used includes an ether-based solvent such as tetrahydrofuran, and an amide-based solvent such as N-methylpyrrolidinone, and an ether-based solvent such as tetrahydrofuran is preferred. The measurement is preferably performed at a solvent flow rate of 0.1 to 2 mL/min, most preferably from 0.5 to 1.5 mL/min. When the measurement is performed in this range, the measurement can be performed more efficiently without imposing a load on the apparatus. The measurement temperature is preferably from 10 to 50° C., and most preferably from 20 to 40° C.

The specific conditions for the measurement of molecular weight are shown below.

Apparatus: HLC-8220GPC (manufactured by TOSOH CORPORATION)

Detector: Differential refractometer (RI detector)

Precolumn: TSK GUARD COLUMN MP (XL), 6 mm×40 mm (manufactured by TOSOH CORPORATION)

Sample-side column: Two of the following column were directly connected (all manufactured by TOSOH CORPORATION).

TSK-GEL Multipore-HXL-M 7.8 mm×300 mm

Reference-side column: Same as the sample-side column

Thermostatic bath temperature: 40° C.

Moving phase: Tetrahydrofuran

Flow rate of sample-side moving phase: 1.0 mL/min

Flow rate of reference-side moving phase: 0.3 mL/min

Sample concentration: 0.1 mass %

Amount of sample injected: 100 μL

Data sampling time: 16 to 46 minutes after sample injection

Sampling pitch: 300 msec

The addition amount of the tri-block copolymer of polyethylene oxide-polypropylene oxide-polyethylene oxide having the above-described molecular weight and PEO content is not particularly limited, as long as a thickening effect due to heating is sufficiently obtained and the tri-block copolymer achieves viscosity such that the ink is ejected from a head of the recording apparatus. However, the tri-block copolymer is added in the range of preferably 2% by mass or more and 15% by mass or less, and more preferably from 3% by mass to 12% by mass. If the addition amount is too small, a thickening effect sometimes may not be sufficiently obtained. On the other hand, if the addition amount is too large, ink viscosity before heating becomes too high, so that ejection of the ink from a head of the recording apparatus sometimes may be affected.

Further, as the heat-sensitive material used in the present invention, it is possible to use two or more kinds of PEO-PPO-PEO tri-block copolymers satisfying the above requirements regarding the molecular weight and PEO content, in combination. In this case, it is preferred to set the total content of the copolymer within the above-described range.

Further, it is preferred that the heat-sensitive material used in the present invention exists in the ink in a solution state. Alternatively, the heat-sensitive material may exist in the ink in an emulsified state. Further, the heat-sensitive materials existing in these different states may be used in combination.

Examples of the tri-block copolymer of PEO-PPO-PEO that may be preferably used include commercially available products marketed as NEWPOL PE-78 (trade name, manufactured by Sanyo Chemical Industries, Ltd.), NEWPOL PE-68 (trade name, manufactured by Sanyo Chemical Industries, Ltd.), NEWPOL PE-108 (trade name, manufactured by Sanyo Chemical Industries, Ltd.), NEWPOL PE-128 (trade name, manufactured by Sanyo Chemical Industries, Ltd.), polyethylene glycol-block polypropylene glycol-block polyethylene glycol (number-average molecular weight of 8,400, manufactured by Aldrich Corporation), and polyethylene glycol-block polypropylene glycol-block polyethylene glycol (number-average molecular weight of 14,600, manufactured by Aldrich Corporation).

In the present invention, by using the above-described PEO-PPO-PEO tri-block copolymer, the ink which has been ejected from a head of the ink-jet recording apparatus and has landed on a recording sheet dries in a short time, and the dot formed after drying has no fluidity. Namely, the dot that is formed by drying shrinkage of ink droplets after landing is stiff, so that the dot hardly changes its shape even if the pressure is applied thereto. As a result, even though the second-order color ink droplets are further ejected on top of the first-order color dot thereby landing on the first-order color dot, both the first-order color dot and the second-order color dot hardly lose their shapes, so that dot bleeding is suppressed even under the high-ejection condition. This reason is not yet clear, but presumed as follows.

It would appear that the ink droplets after landing undergo a process of thickening due to heat received from a heated recording sheet and at the same time a process of evaporating volatile components in the ink to dry the ink droplets. It would appear that, after these processes, the dot is in the state in which volatile components have almost dropped out; namely the state in which almost only the solid components that had been added in the ink remain there. In contrast, since the PEO-PPO-PEO tri-block copolymer used in the present invention has a relatively high melting point, the tri-block copolymer presents a solid state at room temperature. As a result, in the present invention, it is expected that the dots also become stiff due to properties of the PEO-PPO-PEO tri-block copolymer after landing of the ink. Accordingly, in the present invention, it is expected that a stiff first-order color dot and a stiff second-order color dot pile next to one another, so that they become hard to lose their shapes with respect to one another.

### [Pigment]

The ink of the present invention contains a pigment. As the pigment in the present invention, any known pigment can be used without any particular restriction. Above all, a pigment that is substantially insoluble or sparingly soluble in water is preferred from the standpoint of ink coloring properties. In the present invention, a water-insoluble pigment itself or a pigment itself surface-treated with a dispersant can be used as the pigment (colorant).

The pigment that may be used in the present invention is not particularly limited in its kind, and any one of the conventional organic and inorganic pigments may be used. Examples of the pigment that may be used include polycyclic pigments such as azo lake, azo pigment, phthalocyanine pigment, perylene and perynone pigments, anthraquinone pigment, quinacridone pigment, dioxadine pigment, diketopyrrolopyrrole pigment, thioindigo pigment, isoindolinone pigment and quinophthalone pigment; dye lakes such as basic dye type lake and acidic dye type lake; organic pigments such as nitro pigment, nitroso pigment, aniline black and daylight fluorescent pigment; and inorganic pigments such as titanium oxide, iron oxide type and carbon black type. Even pigments that are not described in Color Index can be used so long as they are pigments capable of being dispersed in an aqueous phase. Furthermore, those obtained by surface-treating the above-described pigments with a surfactant, a polymeric dispersant or the like, and grafted carbon can also be used. Of the above pigments, azo pigment, phthalocyanine pigment, anthraquinone pigment, quinacridone pigment and carbon black type pigment are preferably used.

Specific examples of the organic pigment used in the present invention are described below.

Examples of the organic pigment for orange or yellow include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 151, C.I. Pigment Yellow 155, C.I. Pigment Yellow 180 and C.I. Pigment Yellow 185.

Examples of the organic pigment for magenta or red include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222 and C.I. Pigment Violet 19.

Examples of the organic pigment for green or cyan include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Green 7, and siloxane-crosslinked aluminum phthalocyanine described in U.S. Pat. No. 4,311,775.

Examples of the organic pigment for black include C.I. Pigment Black 1, C.I. Pigment Black 6 and C.I. Pigment Black 7.

The average particle diameter of the pigment is preferably from 10 to 200 nm, more preferably from 10 to 150 nm, and further preferably from 10 to 100 nm. When the average particle diameter is 200 nm or less, favorable color reproducibility and dotting properties upon dotting by an inkjet method can be achieved. When the average diameter is 10 nm or more, favorable light fastness can be achieved. The particle size distribution of the pigment is not particularly limited, and the pigment may have a wide range of particle size distribution or a monodispersible particle size distribution. Further, two or more kinds of pigment each having a monodispersible particle size distribution may be used in combination.

The average particle diameter and the particle size distribution of the pigment can be obtained by measuring the volume-average particles diameter of the pigment by a dynamic light scattering method, using a NANOTRACK particle size distribution analyzer (UPA-EX150, trade name, manufactured by Nikkiso Co., Ltd.).

The pigment may be used alone or in combination of two or more kinds. From the viewpoint of image density, the content of pigment in the ink is preferably from 1% by mass to 25% by mass, more preferably from 2% by mass to 20% by mass, still more preferably from 5% by mass to 20% by mass, and particularly preferably from 5% by mass to 15% by mass, with respect to the total amount of the ink composition.

### [Dispersant and Dispersing Medium]

Ordinarily the dispersant is a material to be added for the purpose of dispersing a pigment, and the dispersing medium (binder) is a material to be added for the purpose of improving scratch resistance, solvent resistance, water resistance, and the like. However, in the present invention, a material that is described bellow as the dispersant may be added as a dispersing medium. Accordingly, the dispersant and the dispersing medium are collectively explained below as a dispersant.

The pigment according to the present invention is preferably dispersed in an aqueous solvent by a dispersant. The dispersant may be a polymer dispersant, or a surfactant type dispersant. The polymer dispersant may be either one of a water-soluble dispersant or a water-insoluble dispersant.

The above surfactant type dispersant can be added for the purpose of dispersing an organic pigment stably in an aqueous medium while maintaining the viscosity of the ink at a low level. The surfactant-type dispersant referred to herein is a dispersant of which molecular weight is smaller than that of the polymer dispersant, and the surfactant-type dispersant has a mass average molecular weight of 2,000 or less. The molecular weight of the surfactant-type dispersant is preferably from 100 to 2,000, and more preferably from 200 to 2,000.

As the water-soluble dispersant among the polymer dispersant in the present invention, a hydrophilic polymer compound can be used. Examples of natural hydrophilic polymer compounds include plant polymers such as gum arabic, gum tragacanth, guar gum, gum karaya, locust bean gum, arabinogalactan, pectin and quince seed starch, algae polymers such as alginic acid, carrageenan and agar, animal polymers such as gelatin, casein, albumin and collagen, and microbial polymers such as xanthene gum and dextran.

Examples of hydrophilic polymer compounds obtained by chemically modifying natural raw materials include cellulose polymers such as methyl cellulose, ethyl cellulose, hydroxyethyl cellulose, hydroxypropyl cellulose and carboxymethyl cellulose, starch polymers such as sodium starch glycolate, and sodium starch phosphate, and algae polymers such as propylene glycol alginate.

Examples of synthetic water-soluble polymer compounds include vinyl polymers such as polyvinyl alcohol, polyvinyl pyrrolidone and polyvinyl methyl ether; acrylic resins such as polyacrylamide, polyacrylic acid and alkali metal salts thereof, or water-soluble styrene acrylic resin; water-soluble styrene maleic acid resin; water-soluble vinylnaphthalene acrylic resin; water-soluble vinylnaphthalene maleic acid resins; polyvinyl pyrrolidone; polyvinyl alcohol; alkali metal salts of formalin condensates of β-naphthalene sulfonic acid; polymer compounds having, at a side chain, a salt of a cationic functional group such as a quaternary ammonium group or an amino group.

Among these, a polymer compound containing a carboxyl group or a sulfonyl group is preferable from the viewpoint of dispersion stability of pigment. Polymer compounds containing a carboxyl group such as the following are particularly preferable: (meth)acrylic resins such as styrene-(meth)acrylic resins; styrene maleic acid resins; vinylnaphthalene acrylic resins; vinylnaphthalene maleic acid resins, polyvinylbenzenesulfonate resins, polystyrene-vinylbenzenesulfonate resins, and styrene-vinylsulfonate resins.

The mass average molecular weight of the polymer dispersant in the present invention is preferably from 3,000 to 200,000, more preferably from 5,000 to 100,000, further preferably from 5,000 to 80,000, and still further preferably from 10,000 to 60,000.

The ratio of an amount of the pigment to an amount of the dispersant (pigment: dispersant) in the ink composition in terms of mass is preferably in the range of from 1:0.06 to 1:3, more preferably in the range of from 1:0.125 to 1:2, and still more preferably in the range of from 1:0.125 to 1:1.5.

### [Solvent]

The ink of the present invention is an aqueous ink. As the solvent, water, more preferably ion-exchanged water is used. Any other organic solvent may be contained for the purpose of suppressing drying, accelerating penetration, regulating viscosity, and the like.

A certain organic solvent used as an anti-drying agent can effectively prevent nozzle clogging, which could otherwise be caused by the ink dried in the ink ejecting port in the process of ejecting the ink composition by ink-jet method for image recording.

For the suppression of drying, a hydrophilic organic solvent having a vapor pressure lower than that of water is preferably used. Specific examples of the hydrophilic organic solvent suitable for the suppression of drying include: polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin, and trimethylolpropane; heterocyclic compounds such as 2-pyrrolidone, N-methyl-2-pyrrolidone, 1,3-dimethyl-2-imidazolidinone, and N-ethylmorpholine; sulfur-containing compounds such as sulfolane, dimethylsulfoxide and 3-sulfolene; polyfunctional compounds such as diacetone alcohol and diethanolamine; and urea derivatives. Among these, polyhydric alcohols such as glycerin and diethylene glycol are preferred.

In order to accelerate the penetration, an organic solvent may be used for better penetration of the ink composition into a recording media. Examples of the organic solvent suitable for accelerating the penetration include alcohols such as ethanol, isopropanol, butanol, and 1,2-hexanediol, sodium lauryl sulfate, sodium oleate, and nonionic surfactants.

In addition to the above purposes, the hydrophilic organic solvent may also be used to control viscosity. Specific examples of the hydrophilic organic solvent that may be used to control viscosity include alcohols (e.g., methanol, ethanol and propanol), amines (e.g., ethanolamine, diethanolamine, triethanolamine, ethylenediamine, and diethylenetriamine), and other polar solvents (e.g., formamide, N,N-dimethylformamide, N,N-dimethylacetamide, dimethylsulfoxide, sulfolane, 2-pyrrolidone, acetonitrile, and acetone).

The content of the organic solvent is preferably from 0% by mass to 80% by mass, more preferably from 0% by mass to 60% by mass, and still more preferably from 0% by mass to 50% by mass with respect to the total amount of the ink.

### [Water]

The ink used in the present invention contains water. There is no particular limitation to the content of water in the ink. The content of water may be from 10% by mass to 99% by mass, more preferably from 30% by mass to 80% by mass, and still more preferably 50% by mass to 70% by mass with respect to the total amount of the ink.

### [Other Additives]

The ink composition of the invention may further contain other additives in accordance with necessity. Examples of such other additives include known additives such as a color fading inhibitor, an emulsion stabilizer, a permeation accelerator, an ultraviolet absorbent, a preservative, a mildew-proofing agent, a pH regulator, a surface tension regulator, a defoaming agent, a viscosity adjusting agent, a dispersant, a dispersion stabilizer, an anti-rust agent and a chelating agent. These various additives may directly be added after preparation of the ink composition, or may be added at the time of preparation of the ink composition.

### [Ultraviolet Absorbent]

The ultraviolet absorbent is used for the purpose of improving preservability of an image. As the ultraviolet absorbent, the following compounds can be used; benzotriazole compounds described in, for example, JP-A-58-185677, JP-A-61-190537, JP-A-2-782, JP-A-5-197075 and JP-A-9-34057; benzophenone compounds described in, for example, JP-A-46-2784 and JP-A-5-194483, and U.S. Pat. No. 3,214,463; cinnamic acid compounds described in, for example, JP-B-48-30492 (“JP-B” means examined Japanese patent publication) and JP-B-56-21141, and JP-A-10-88106; triazine compounds described in, for example, JP-A-4-298503, JP-A-8-53427, JP-A-8-239368 and JP-A-10-182621, and JP-T-8-501291 (“JP-T” means published Japanese translation of PCT application); compounds described in Research Disclosure No. 24239; and compounds that absorb ultraviolet light and emit fluorescence, i.e., fluorescent brighteners, typified by stilbene compounds or benzoxazole compounds.

### [Color Fading Inhibitor]

The color fading inhibitor is used for the purpose of improving storability of an image. Examples of the color fading inhibitor that can be used include various organic color fading inhibitors and metal complex color fading inhibitors. Examples of the organic color fading inhibitor include hydroquinones, alkoxyphenols, dialkoxyphenols, phenols, anilines, amines, indanes, chromanes, alkoxyanilines and heterocycles. Examples of the metal complex color fading inhibitor include a nickel complex and a zinc complex. More specifically, compounds described in the patents cited in Research Disclosure No. 17643, chapter VII, items I to J; Research Disclosure No. 15162: Research Disclosure No. 18716, page 650, the left-hand column; Research Disclosure No. 36544, page 527; Research Disclosure No. 307105, page 872; and Research Disclosure No. 15162, and compounds included in the formulae of the representative compounds and the exemplified compounds described on pages 127 to 137 of JP-A-62-215272 can be used.

### [Mildew-Proofing Agent]

Examples of the mildew-proofing agent include sodium dehydroacetate, sodium benzoate, sodium pyridinethion-1-oxide, p-hydroxybenzoic acid ethyl ester, 1,2-benzisothiazolin-3-one and its salt. These are preferably used in the ink composition in an amount of from 0.02 to 1.00% by mass.

### [pH Regulator]

As the pH regulator, a neutralizer (organic base and inorganic alkali) may be used. The pH regulator may be added in an amount such that the ink composition has pH of preferably from 6 to 10, and more preferably from 7 to 10, from the view point of improving storage stability of the ink composition.

### [Surface Tension Regulator]

Examples of the surface tension regulator include nonionic surfactants, cationic surfactants, anionic surfactants, and betaine type surfactants.

For smooth ejection in the ink-jet recording method, the amount of addition of the surface tension regulator is preferably such that the surface tension of the ink composition can be adjusted in the range of from 20 mN/m to 60 mN/m, more preferably from 20 mN/m to 45 mN/m, further preferably from 25 mN/m to 40 mN/m. When the ink is applied by methods other than ink-jet methods, the amount of addition of the surface tension regulator is preferably such that the surface tension of the ink composition can be adjusted in the range of from 20 mN/m to 60 mN/m, more preferably from 30 mN/m to 50 mN/m.

The surface tension of the ink composition may be measured by a plate method using Automatic Surface Tensiometer CBVP-Z (trade name, manufactured by Kyowa Interface Science Co., LTD.) under the temperature condition of 25° C.

### [Surfactant]

Specific examples of the hydrocarbon-series surfactant include anionic surfactants such as fatty acid salts, alkyl sulfate ester salts, alkyl benzenesulfonates, alkyl naphthalenesulfonates, dialkyl sulfosuccinates, alkyl phosphate ester salts, naphthalenesulfonic acid-formalin condensates, and polyoxyethylene alkyl sulfate ester salts; and nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkylamines, glycerin fatty acid esters, and oxyethylene-oxypropylene block copolymers. Acetylene polyoxyethylene oxide surfactants SURFYNOLs (trade name, manufactured by Air Products & Chemicals, Inc.) are also preferably used. Amine oxide type amphoteric surfactants such as N,N-dimethyl-N-alkylamine oxide are also preferable.

The surfactants listed in pages 37 to 38 of JP-A-59-157636 and Research Disclosure No. 308119 (1989) may also be used.

Fluorocarbon (alkyl fluoride type) surfactants or silicone surfactants as described in JP-A-2003-322926, JP-A-2004-325707 and JP-A-2004-309806 may be used to improve a scratch resistance.

The surface tension regulator may also be used as a defoaming agent, and fluorine-series compounds, silicone-series compounds, and chelating agents as typified by EDTA may also be used.

In the ink of the present invention, a thickener, a conductivity improver, a kogation inhibitor (“kogation” means solid deposits baked onto the surface of a heater), a desiccant, a water-resistant ruggedization agent, a light stabilizer, a buffering agent, an anti-curling agent, or the like further may be added. Examples of the buffering agent include sodium borate, sodium hydrogenphosphate, sodium dihydrogenphosphate, and a mixture thereof. However, the buffering agent is not limited thereto.

Next, the ink-jet recording method, ink-jet recording apparatus and printed matter of the present invention will be described.

### [Ink-Jet Recording Method]

The ink-jet recording method is a method to form images by ejecting ink droplets from a plurality of nozzles or orifices built in a printer head of an ink-jet printer, and allowing the ink droplets to land on a recording sheet while controlling the ink droplets by the ejection. This method is roughly classified into a method of ejecting liquid droplets by applying a mechanical energy to the liquid droplets and a method of ejecting liquid droplets by bubble release resulting from application of heat energy to the liquid droplets. In the present invention, any one of these methods may be used.

The printing speed is not particularly limited. However, since the present invention makes it possible to obtain excellent images even in a high-speed printing, the range of from 50 m/min to 200 m/min is preferred. Though the liquid amount per droplet is not particularly limited, the range of from 2 to 15 pl is preferred.

In the ink-jet recording method of the present invention, the above-described ink of the present invention is used. In the case of color printing, it is sufficient that at least one of the inks used in the ink set is the ink of the present invention. In addition, the ink-jet recording method of the present invention is characterized in that the recording sheet is heated to 80° C. or higher before the ink droplets land, or at the time of landing, preferably in the range of from 80° C. to 100° C., more preferably in the range of from 80° C. to 90° C. This heating temperature is defined as a value obtained by measuring a temperature at the side of the ink-jet recording (the side at which ink droplets are landed) of the recording sheet using a noncontact thermometer such as an infrared thermometer (for example, IR-66B (trade name), manufactured by MK Scientific, Inc.). The measuring position is set between a head unit of the ink-jet recording apparatus and a means (unit) that heats a recording sheet. If the heating temperature is lower than 80° C., the ink may not sufficiently be thickened. Further, in order to heat to a higher temperature than the above-described temperature, extra heat sources are needed. As a result, the extra heat sources become a load on the system. In addition, heating may be carried out both before the ink droplets land and at the time of landing. In the method of the present invention, the thickening of the ink on a recording sheet is accelerated by heating on the recording sheet whereby, for example, bleeding can be suppressed.

The recording sheet to be used may be, but not limited to, a sheet of general printing paper (plain paper) containing cellulose as a main component, such as so-called high-quality paper, coated paper, or art paper. When general printing paper containing cellulose as a main component is used in image recording by a conventional ink-jet method with a water-based ink, the ink may be absorbed in the paper and dried relatively slowly, so that colorants in the ink may be likely to migrate after being provided on the paper, which may easily lead to image quality deterioration. According to the ink-jet recording method of the invention, however, the migration of the colorants may be suppressed so that high-quality image recording with good color density and suppression of penetration may be achieved.

Generally commercially available recording sheet may be used as the recording sheet, and examples thereof include high-quality paper (A) such as OK PRINCE HIGH-QUALITY (trade name, manufactured by Oji Paper Co., Ltd.), SHIORAI (trade name, manufactured by Nippon Paper Industries Co., Ltd. and NEW NPI HIGH-QUALITY (trade name, manufactured by Nippon Paper Industries Co., Ltd.); lightly coated paper such as OK EVER LIGHT COAT (trade name, manufactured by Oji Paper Co., Ltd.) and AURORA S (trade name, manufactured by Nippon Paper Industries Co., Ltd.); lightweight coated paper (A3) such as OK COAT L (trade name, manufactured by Oji Paper Co., Ltd.) and AURORA L (trade name, manufactured by Nippon Paper Industries Co., Ltd.); coated paper (A2, B2) such as OK TOP COAT+ (trade name, manufactured by Oji Paper Co., Ltd.) and AURORA Coat (trade name, manufactured by Nippon Paper Industries Co., Ltd.); and art paper (A1) such as OK KANAFUJI+ (trade name, manufactured by Oji Paper Co., Ltd.) and TOKUBISHI ART (trade name, manufactured by Mitsubishi Papers Mills Ltd.).

### [Ink-Jet Recording Apparatus]

The ink-jet recording apparatus of the present invention is an ink-jet recording apparatus equipped with a recording unit including an ink-containing section that contains an ink, and a head unit for ejecting the ink in the form of liquid droplets, which is characterized in that the ink is the above-described ink-jet pigment ink of the present invention, and the ink-jet recording apparatus further includes a heating and retaining means (hereinafter referred to as “a heating means”) that maintains a temperature by heating a recording sheet so that the recording sheet reaches 80° C. or higher, preferably in the range of from 80° C. to 100° C., more preferably in the range of from 80° C. to 90° C. before the ink droplets land on a recording sheet, or at the time of landing. According to this apparatus, the above-described ink-jet recording method of the present invention can be carried out.

The heat source as a heating means is not particularly limited, as long as a recording sheet is heated by the heat source to a required temperature, so that an ink is sufficiently thickened. Specific examples of the heat source include a heat plate, a heat drum, light irradiation, a hot-air source, an electric heater, an infrared lamp, and an infrared laser. If needed, these means may be used in combination. Further, the heating means may be disposed above a recording sheet, or may be below the recording sheet. In addition, a positional relation of the heating means with the head unit is arbitrary, as long as a recording sheet is heated by the heating means to a required temperature before the ink droplets land on a recording sheet, or at the time of landing.

The recording unit is not particularly limited, as long as it is a recording unit that is already used in an ordinary ink-jet printer. Examples of the recording unit include the structure described in paragraphs [0061] to [0062] of JP-A-8-333536.

Further, the ink-jet recording apparatus of the present invention preferably has a structure in which a head and a heating unit (heating means) are disposed at a short distance so that ink droplets can land on a recording sheet before a heated recording sheet has gotten chilled. However, if the distance is too short, a heat from a heating unit conducts to a head, and the ink is thicken in the head, which sometimes results in going into a failure of ejection. Accordingly, it is preferred to assemble the apparatus into a structure in which a head is distatiated from a heating unit enough to meet the requirement that ejectability of the ink in the head is not lost, or a structure in which a head is protected with a heat insulation material in order to block heat from the heating unit.

### [Printed Matter]

The printed matter of the present invention is not particularly limited, as long as it is a material in which characters or images are printed on a recording sheet using the above-described ink of the present invention according to an ink-jet recording method of the present invention.

The present invention is contemplated for providing an ink-jet pigment ink in which dot bleeding is improved, especially such an ink that the second-order color dot bleeding is prevented even if printed under high ejection conditions, and the penetration of the ink through the paper is suppressed. Further, the present invention is contemplated for providing an ink-jet recording method using the above-described pigment ink whereby both dot bleeding and penetration of the ink through the paper are reduced. In addition, the present invention is contemplated for providing an ink-jet recording apparatus by which the above-described ink-jet recording method can be carried out.

The ink-jet pigment ink of the present invention exhibits excellent function effects such that bleeding is reduced even if printed under high ejection conditions, and penetration of the ink through the paper is suppressed. According to both the ink-jet recording method and the ink-jet recording apparatus of the present invention, by using the above-described ink-jet pigment ink, it is possible to form, in high speed, images having such excellent quality that both dot bleeding are suppressed and penetration of the ink through the paper is reduced.

The present invention will be described in more detail based on the following examples, but the invention is not intended to be limited thereto. In the following examples, the terms “part(s)” and “%” are values by mass, unless otherwise specified.

### EXAMPLES

### Example I

### Example 1

### (Preparation of Black Ink 101-K)

The following compounds were weighed, mixed and stirred to prepare Black ink 101-K.

| | | |
|---|---|---|
| Black pigment dispersion (carbon black, | 26.67 | g |
| water dispersion (15% by mass )) | | |
| NEWPOL PE-108 (trade name, | 5.0 | g |
| manufactured by Sanyo Chemical | | |
| Industries, Ltd.) PEO-PPO-PEO | | |
| triblock polymer | | |
| Surfactant (Olfine E1010 (trade name, | 1.0 | g |
| Nissin Chemical Industry Co., Ltd.)) | | |
| Ion-exchanged water | 68.13 | g |

### (Preparation of Magenta Ink 101-M)

Magenta ink 101-M was prepared in the same manner as Black ink 101-K except that a magenta pigment dispersion (15% by mass water dispersion of Pigment Red 122) was used instead of the above black pigment dispersion.

### Example 2

Black ink 102-K and Magenta ink 102-M were prepared in the same manner as Example 1 except that NEWPOL PE-108 was changed to 5.0 g of NEWPOL PE-78 (trade name, manufactured by Sanyo Chemical Industries, Ltd.) and the amount of water was changed to 68.13 g.

### Example 3

Black ink 103-K and Magenta ink 103-M were prepared in the same manner as Example 1 except that NEWPOL PE-108 was changed to 7.0 g of NEWPOL PE-68 (trade name, manufactured by Sanyo Chemical Industries, Ltd.) and the amount of water was changed to 65.33 g.

### Comparative Example I

### Comparative Example 1

Black ink c11-K and Magenta ink c11-M were prepared in the same manner as Example 1 except that NEWPOL PE-108 was changed to 15.0 g of NEWPOL PE-64 (trade name, manufactured by Sanyo Chemical Industries, Ltd.) and the amount of water was changed to 57.33 g.

### Comparative Example 2

Black ink c12-K and Magenta ink c12-M were prepared in the same manner as Example 1 except that NEWPOL PE-108 was changed to 10.0 g of Pluronic P85 (trade name, manufactured by BASF Corporation) and the amount of water was changed to 62.33 g.

### Comparative Example 3

Black ink c13-K and Magenta ink c13-M were prepared in the same manner as Example 1 except that NEWPOL PE-108 was changed to 10.0 g of polyethyleneglycol (manufactured by Aldrich Corporation) and the amount of water was changed to 62.33 g.

The molecular weight of the polymers and PEO ratio (% by mass relative to the total amount of the polymer) used in the above-described Examples 1 to 3 and Comparative Examples 1 to 3 are shown together in Table 2. The molecular weight is a value obtained by measurement according to the above-described method.

### (Evaluation of Viscosity)

Measurement of ink viscosity (m Pa·s) at each temperature shown in Table 1 ranging from 25° C. to 90° C. was conducted with respect to Black ink 102-K and Magenta ink 102-M.

The value of viscosity was defined as an average of the values obtained by measuring a viscosity five times every 100 seconds after the test sample has been adjusted to a predetermined temperature shown in Table 1 using a temperature-variable type rotational viscometer Physica MCR301 (trade name, manufactured by Anton Paar GmbH). As the measuring conditions, shear rate of 10 (1/s) and rate of temperature rise of 5° C./5 seconds were used.

The results are shown in Table 1.

TABLE 1

| Temperature | Viscosity (mPa · s) | |
|---|---|---|
| (° C.) | 102-K | 102-M |
| 25 | 4.1 | 3.5 |
| 30 | 3.8 | 3.3 |
| 40 | 3.3 | 3.1 |
| 50 | 3.0 | 2.9 |
| 60 | 2.8 | 2.4 |
| 70 | 4.0 | 3.4 |
| 80 | 121.0 | 118.0 |
| 90 | 361.0 | 245.3 |

### Example II

### Comparative Example II

Black inks and Magenta inks shown in Table 2 were ejected, as the first-order color and the second-order color respectively, from a piezoelectric head (384 nozzles) in a single pass mode at resolution of 600 dpi in a droplet amount of from 7 to 8 pl per liquid droplet. Thereby, five-step 1 cm×1 cm halftone dot images (two colors) of which halftone percentage is 100%, 80%, 60%, 40% and 20% respectively were printed in order on a NPi high-quality paper (trade name, manufactured by Nippon Paper Industries, Co., Ltd.). Heating was carried out by hot air before the ink lands so that the NPi high-quality paper is heated to 80° C. The temperature of the NPi high-quality paper is a value obtained by measuring a temperature at the side of a recording face (the side at which ink droplets land) in the mid position between a heat source and the piezoelectric head using an infrared thermometer (IR-66B (trade name), manufactured by MK Scientific, Inc.).

Evaluation of the printed matters was conducted as follows.

### (Evaluation of Bleeding)

Each of printed images of which halftone percentage is 100%, 80%, 60%, 40% and 20% was observed by a microscope (20 magnifications). According to the following criterion, the printed matters were evaluated with respect to the first-order color dot (black) and the second-order color dot (magenta). The results are shown in Table 2.

A: Bleeding of almost dots is suppressed.
B: Bleeding of about half dots is suppressed.
C: Bleeding of a part of dots is suppressed.
D: Almost dots are bleeding.

### (Evaluation of Penetration of Ink)

The reverse side of the printed images was visually observed. Evaluation was conducted according to the following criterion. The results are shown in Table 2. The less the penetration of the ink through the paper is, the higher the color density of the printed surface becomes, which is preferable.

A: Penetration of the ink through the paper is very little.
B: Penetration of the ink through the paper is little.
C: Penetration of the ink through the paper is apparently observed.

### (Fluidity of Residue)

A drop (about 0.01 g) of ink was dropped by a dropper into an aluminum cup and left on over night thereby removing volatile components. Thereafter, a residue was scratched with a spatula. The residue in which a lump got broken was judged as existence of fluidity. On the other hand, the residue in which a lump underwent deformation and got crushed without getting broken was judged as non-existence of fluidity. The results were shown in Table 2. When printing is conducted by the ink-jet recording method, the less a residue has fluidity, the more the formed dot is difficult to collapse.

TABLE 2

| | | Polymer | | | | Dot bleed | Dot bleed of | |
|---|---|---|---|---|---|---|---|---|
| | | | Molecular | PEO ratio | Fluidity of | of first-order | second-order | Penetaration |
| | Ink | Polymer | weight | (mass %) | Residue | color | color | of Ink |
| Example 1 | 101-K | PE-108 | 16,000 | 85 | Non-existence | A | A | B |
| | 101-M | | | | | | | |
| Example 2 | 102-K | PE-78 | 9,000 | 81 | Non-existence | A | A | B |
| | 102-M | | | | | | | |
| Example 3 | 103-K | PE-68 | 9,000 | 85 | Non-existence | A | A | B |
| | 103-M | | | | | | | |
| Comparative | c11-K | PE-64 | 3,000 | 46 | Existence | B | D | D |
| example 1 | c11-M | | | | | | | |
| Comparative | c12-K | Pluronic P85 | 5,000 | 57 | Existence | B | D | C |
| example 2 | c12-M | | | | | | | |
| Comparative | c13-K | Polyethylene | 1,000 | 100 | Existence | C | D | D |
| example 3 | c13-M | oxide | | | | | | |

In the printed matters obtained by using inks of Comparative Examples 1 to 3, before the first-order color dot completely gets hard, the second-order color dot lands thereon. As a result, bleeding of the second-order color dot occurs. In addition, penetration of the ink through the paper is observed, so that a color density is not enough.

In contrast, in the printed matters obtained by using inks of Examples 1 to 3, high-quality prints are obtained such that the shape of the first-order color dot is not collapsed; bleeding of the second-order color dot is suppressed; and bleeding is prevented even in a high-print density portion (high ejection portion) as a whole printed matter. Further, these printed matters exhibit such excellent effects that the penetration of the ink through the paper is improved and a color density is high. In addition, the dot shape of the printed matters of Examples 1 to 3 was a trapezoid in section, and the density was uniform, which resulted in excellent image quality.

Having described our invention as related to the present embodiments, it is our intention that the present invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-050976 filed in Japan on Mar. 8, 2010, which is entirely herein incorporated by reference.

What we claim is:

1. An ink-jet pigment ink, comprising: at least one tri-block copolymer of polyethylene oxide-polypropylene oxide-polyethylene oxide having a number-average molecular weight of 8,000 or more and 30,000 or less and a content of polyethylene oxide of 60% by mass or more and 90% by mass or less with respect to the total mass of the copolymer, wherein a viscosity of the ink-jet pigment ink increases by heating.

2. The ink-jet pigment ink according to claim 1, wherein the ink contains the tri-block copolymer of polyethylene oxide-polypropylene oxide-polyethylene oxide in an amount of from 2% by mass or more and 15% by mass or less based on the ink.

3. An ink-jet recording method, comprising the step of: printing on a recording sheet by ejecting ink droplets from an orifice of a recording head in response to recording signals,
wherein the ink is the ink-jet pigment ink according to claim 1, and
wherein the recording sheet is heated to 80° C. or higher before the ink droplets land, or at the time of landing.

4. A printed matter comprising a recording sheet having been printed thereon by the ink-jet recording method according to claim 3.

5. An ink-jet recording apparatus, comprising: a recording unit,
wherein the recording unit is equipped with an ink containing section that contains an ink and a head unit that ejects the ink in the form of liquid droplets,
wherein the ink is the ink-jet pigment ink according to claim 1, and
wherein the ink-jet recording apparatus further comprises a heating and retaining means that maintains the temperature of a recording sheet at 80° C. or higher by heating before the ink droplets land, or at the time of landing.
